(19) United States
(12) Patent Application Publication
(10) Pub. No.: US 2011/0188571 A1
(43) Pub. Date: Aug. 4, 2011

(54) RECURSIVE ADAPTIVE INTERPOLATION FILTERS (RAIF)

(75) Inventors: Ehsan Maani, San Jose, CA (US); Wei Liu, San Jose, CA (US)

(73) Assignee: SONY CORPORATION, Tokyo (JP)

(21) Appl. No.: 13/018,587

(22) Filed: Feb. 1, 2011

Related U.S. Application Data
(60) Provisional application No. 61/301,430, filed on Feb. 4, 2010.
(60) Provisional application No. 61/322,757, filed on Apr. 9, 2010.

(51) Int. Cl. H04N 7/32

(52) U.S. Cl. 375/240.12; 375/E07.243

(57) ABSTRACT

Adaptive interpolation filters which are recursively updated based on previously reconstructed images, and which can differ within a single frame as they adapt to spatial changes. An initial set of filters is known within a coding system, including both encoder and decoder. Fractional-pel motion estimation of macroblock is generalized by communicating integer-pel motion vectors and an index to a selected prediction interpolation filter. Prediction filters are updated based on local correlation data comprising auto-correlation data, and/or cross-correlation data.

### CROSS-REFERENCE TO RELATED APPLICATIONS

This application claims priority from U.S. provisional patent application Ser. No. 61/322,757 filed on Apr. 9, 2010, and from U.S. provisional patent application Ser. No. 61/301,430 filed on Feb. 4, 2010, each of which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to video compression, and more particularly to adaptive interpolation filters for increasing video coding prediction accuracy.

2. Description of Related Art

The majority of video coding systems utilize a hybrid structure which includes inter-frame prediction (inter prediction) and transform coding. Inter prediction plays an important role in exploiting the temporal correlation among the video signal to obtain high compression efficiency in video codecs. Inter prediction on these coding systems typically utilizes the concept of Motion Compensated Prediction (MCP). In these systems an inter-predictive coded video frame (P-frame) is partitioned into blocks, which can be of different sizes. For each block, a Motion Vector (MV) is transmitted, pointing to a previously decoded block (e.g., reference block). Only the difference between the reference block and the current block (residual) is coded.

It will be appreciated that the more accurate the determination of a motion vector (MV), and the smaller the energy of the residual signal to be coded, the higher will be the coding efficiency. The use of fractional-pel Motion Estimation (ME) has been advanced for improving motion vector accuracy, as the displacement of a moving object between frames might not always be integer-pels. Use of fractional-pel ME allows the encoder to send MVs pointing to sub-pel positions (e.g., half-pel or quarter-pel). However, since the decoder does not have sampling values at the sub-pel positions, interpolation is necessary. For example, in H.264/AVC, a fixed 6-tap interpolation filter is utilized for the half-pel positions.

In the H.264/AVC video coding standard, quarter-pel MCP is allowed, which results in 16 sub-pel positions. For each of these sub-pel positions, there is a fixed filter, which is known by both the encoder and the decoder. The use of an Adaptive Interpolation Filter (AIF) was advanced to improve these fixed interpolation filters. For each sub-pel position, an adaptive interpolation filter is trained by the encoder to obtain better prediction performance. The filter coefficients are updated per frame and signaled to the decoder through extra bits as side information encoded into the bit stream.

AIF is configured to operate using two-pass Motion Estimation (ME). Pass 1 of ME is performed before the training to gather the statistics of each sub-pel position, with Pass 2 performed after the training to determine the best prediction. However, AIF has a number of drawbacks, such as in regard to high complexity and overhead, lack of local adaptability, and the need of two passes of ME. It will be recognized that signaling of the filter coefficients to the decoder requires extra overhead, as extra bits must be encoded into the bit stream. In addition, AIF filters are designed globally and are not adaptive to local changes, in view of their training over the entire frame, and AIF techniques inherently require multiple passes.

Accordingly, a need exists for a method and system of enhancing interpolation filters to overcome the shortcomings of existing AIF filters. The present invention fulfills that need and overcomes the shortcomings of existing systems.

### BRIEF SUMMARY OF THE INVENTION

A Recursive Adaptive Interpolation Filter (RAIF) is taught herein, which overcomes a number of shortcomings of AIF filters. It can be said that RAIF generalizes the concept of fractional-pel ME. For example, instead of sending a fractional value MV, the integer-pel MV is sent along with the index of the best prediction filter. It should be noted that if the set of filters comprise the fixed interpolation filters, then the MV becomes the conventional fractional-pel ME, whereas if the set of filters is fixed for each frame, the operation essentially reverts to AIF.

After each macroblock (MB) is coded, the filters are updated based on the collected statistics of the coded MB and the reference block appointed by the integer-pel MV. Accordingly, the filters can differ even within the same frame. The filters are not necessarily for sub-pel interpolation, but potentially to reflect more generalized transformation of the reference block, such as motion blur or fading

A number of advantages are provided by the RAIF apparatus and method over that of AIF, including but not limited to the following. The filters have the ability to adapt to spatial changes in the picture, and can represent more generalized motion models, such as in addition to translational motion. The invention can be practiced as to require no overhead for communication of filter coefficients as side information to the decoder. In addition, the method can be performed in a single-pass and with a substantially lower encoder complexity.

The invention is amenable to being embodied in a number of ways, including but not limited to the following descriptions.

One embodiment of the invention is an apparatus for prediction interpolation filtering of a video signal having a sequence of frames within a video coder, comprising: (a) a computer configured for processing video signals; (b) a memory coupled to said computer; and (c) programming configured for retention on said memory and executable on said computer for, (c)(i) establishing an initial set of filters which are known for both encoding and decoding within a video coder, (c)(ii) selecting a prediction filter, as a selected prediction filter, based on which filter optimizes accurate prediction for a macroblock, (c)(iii) generalizing fractional-pel motion estimation of said macroblock by communicating integer-pel motion vectors and an index to a selected prediction filter, (c)(iv) gathering local correlation data, (c)(v) updating the prediction interpolation filters utilized for the next macroblock based on said local correlation data.

At least one embodiment of the invention is configured for changing interpolation filters on-the-fly as image encoding progresses as prediction interpolation filter design is based on previously reconstructed sample values. At least one embodiment of the invention is configured for separately coding indices for said prediction interpolation filters, with a prediction obtained of a current filter index from neighboring indices. At least one embodiment of the invention is configured for performing prediction interpolation filtering in a single pass. At least one embodiment of the invention is configured for using local correlation data which comprises auto-correlation data, and/or cross-correlation data. At least one embodiment of the invention is configured for updating of prediction interpolation filters by updating auto-correlation data Rₓₓ^{k}, and cross-correlation data R_{xy}^{k}, and a filter of class k is given by H^{k} using the following formulas:

Rₓₓ^{k}(i+1)=(1−α)×Rₓₓ^{k}(i)+α×δRₓₓ^{k}(i)

R_{xy}^{k}(i+1)=(1−α)×R_{xy}^{k}(i)+α×δR_{xy}^{k}(i)

H^{k}(i)=[Rₓₓ^{k}(i)]⁻¹R_{xy}^{k}(i)

where value α is a number between 0 and 1, while the changes (deltas) of Rₓₓ^{k} and R_{xy}^{k} are shown as δRₓₓ^{k} and δR_{xy}^{k} using prediction interpolation filter k at step i. It should be noted that auto- and cross-correlation matrix updates δRₓₓ^{k} and δR_{xy}^{k} are computed from the newly coded (decoded) macroblock(s) at the encoder (decoder).

At least one embodiment of the invention is configured using different prediction interpolation filters within a single frame of video, and which adapts to spatial changes; and in which said prediction interpolation filters are both a function of time instance and location in the image. At least one embodiment of the invention is configured so that no prediction interpolation filter coefficient side information needs to be sent to the decoder. At least one embodiment of the invention is configured for fractional-pel motion estimation by one-half pel positions, and/or one-quarter pel positions. At least one embodiment of the invention is configured for selecting a prediction interpolation filter in response to

$${min}_{k} {‖ y - {H}^{k} \hat{x} ‖}_{1} + λ R ( k )$$

where y represents the original block, \hat{x} represents the reconstructed reference block, λ is a fixed multiplier, R(k) is the rate associated with the filter index k, and {H^{k}} represents a set of filters {H^{k}} initially configured and known to both encoder and decoder, with value k indicating filter number within this set which can contain any desired number of prediction interpolation filters.

At least one embodiment of the invention is configured so that a motion vector (MV) and value k as a filter index are sent as pair (MV,k), to a decoder. At least one embodiment of the invention is configured with programming to perform its own computations to update its set of interpolation filters and remains in synchronization with an encoder. At least one embodiment of the invention is configured to transmit a 1-bit signal, from an encoder to a decoder, for selecting either recursive adaptive interpolation filters (RAIF) or filters for advanced video coding (AVC) standard.

One embodiment of the invention is an apparatus for interpolation filtering of a video signal having a sequence of frames within a video coder, comprising: (a) a computer configured for processing video signals; (b) a memory coupled to said computer; and (c) programming configured for retention on said memory and executable on said computer for, (c)(i) establishing an initial set of filters which are known for both encoding and decoding within a video coder, (c)(ii) selecting a prediction filter, as a selected prediction filter, based on optimizing accurate prediction for a macroblock, (c)(iii) generalizing fractional-pel motion estimation of said macroblock by communicating integer-pel motion vectors and an index to a selected prediction interpolation filter, (c)(iv) gathering local correlation data comprising auto-correlation data, and/or cross-correlation data, (c)(v) performing prediction interpolation filtering in a single pass, as both a function of time instance and location in the image, (c)(vi) updating the prediction filters utilized for the next macroblock based on said local correlation data.

One embodiment of the invention is a method of performing prediction interpolation filtering of a video signal having a sequence of frames within a video coder, comprising: (a) establishing an initial set of filters which is known for both encoding and decoding within a video coder; (b) selecting a prediction filter, as a selected prediction filter, based on optimizing accurate prediction for a macroblock; (c) generalizing fractional-pel motion estimation of said macroblock by communicating integer-pel motion vectors and an index to a selected prediction filter; (d) gathering local correlation data; and (e) updating the prediction interpolation filters utilized for the next macroblock based on said local correlation data.

The present invention provides a number of beneficial elements which can be implemented either separately or in any desired combination without departing from the present teachings.

An element of the invention is an apparatus and method of prediction interpolation filtering in which the filters are recursive and adaptable to local statistics.

Another element of the invention is the ability to select the most accurate prediction for each block in a Rate-Distortion (RD) fashion.

Another element of the invention is the generalizing of fractional-pel motion estimation in response to communicating integer-pel motion vectors and an index to a selected prediction filter.

Another element of the invention is the use of local signal correlation data, including auto-correlation data, and/or cross-correlation data.

Another element of the invention that prediction interpolation filters are determined in response to both a function of time instance and location in the image.

A still further element of the invention is that the method can be implemented without the need of sending additional side information to the decoder for selecting the interpolation filter (i.e., filter indices are signaled as sub-pel motion vectors).

Further elements of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a coding apparatus having an RAIF filter according to an embodiment of the present invention.

FIG. 2 is a diagram of generalized motion estimation utilized according to one element of the present invention.

FIG. 3 is a schematic of interpolation filters used within a macroblock to be updated according to an element of the present invention.

FIG. 4 is a set of calculations for updating prediction interpolation filters according to an element of the present invention.

FIG. 5 is a schematic of scanning order for macroblocks according to an element of the present invention.

FIG. 6 is a schematic of the filter update process according to an element of the present invention.

FIG. 7 is a flowchart of the RAIF method according to an embodiment of the present invention.

### DETAILED DESCRIPTION OF THE INVENTION

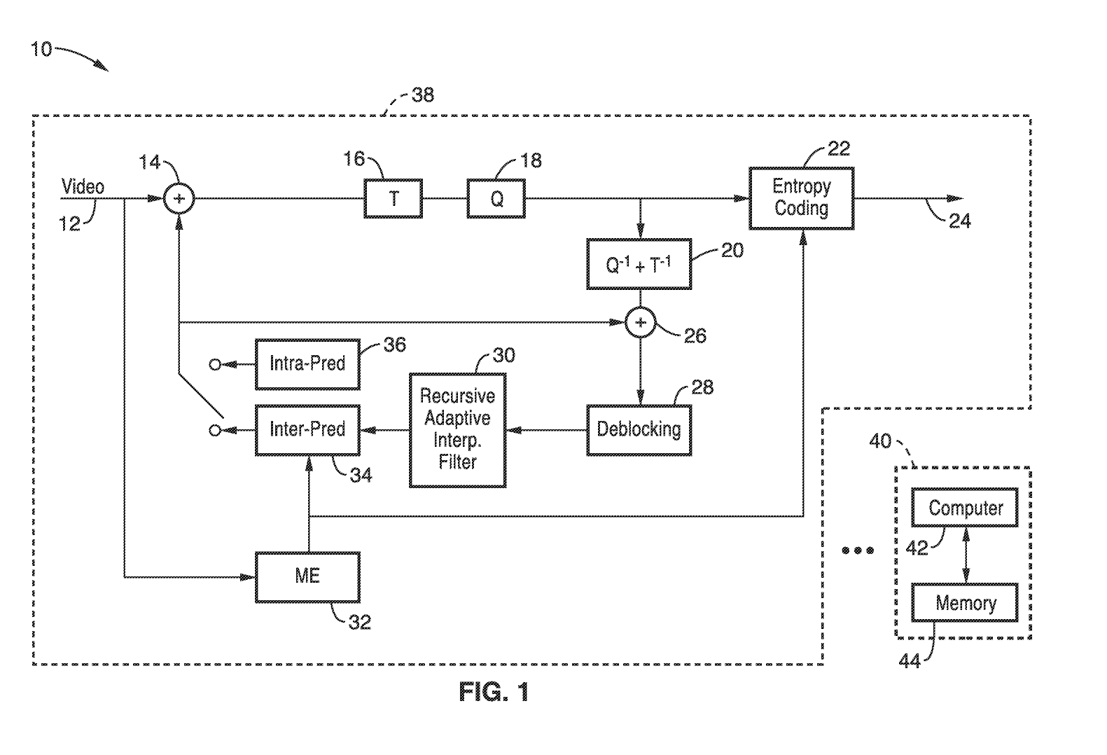

FIG. 1 illustrates a coding system 10 having recursive adaptive interpolation filter (RAIF) according to an embodiment of the present invention. It will be appreciated that interpolation filters according to the invention are used in both the encoder and decoder, with no need of the encoder to send side information to the decoder for selecting the proper filters. A video signal 12 is received and summed 14 with a residual, after which a transform 16 is performed followed by quantization 18. The quantized signal is entropy coded 24. Inverse quantization and transform 20 are performed prior to summing 26, deblocking (deblock filtering) 28 and recursive adaptive interpolation filtering (RAIF) 30 in preparation for prediction, including inter-predictions 34 in response to motion estimations (ME) 32, and intra-prediction 36. The system according to the invention preferably comprises an encoder 38 and a decoder, the steps of each being preferably performed in response to programming executing on a processing element 40, such as at least one computer 42 executing programming stored on at least one associated memory 44. In addition, it will be appreciated that elements of the present invention can be implemented as programming stored on a media, wherein the media can be accessed for execution by computer 42.

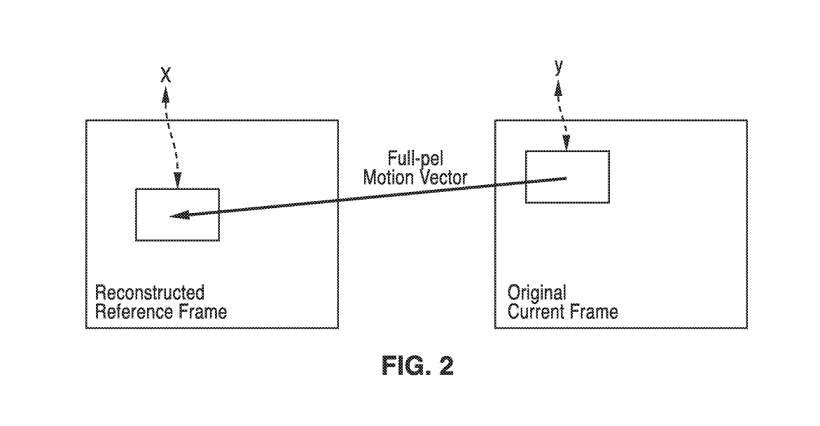

FIG. 2 illustrates an example of searching the full-pel MV in a typical manner, with a block x in the reconstructed reference frame in response to a full-pel motion vector for a block in the original frame according to the use of a generalized motion estimation in the present invention.

A filter is selected that provides the best prediction in an RD sense, as given by:

$${min}_{k} {‖ y - {H}^{k} \hat{x} ‖}_{1} + λ R ( k )$$

where y represents the original block, \hat{x} represents the reconstructed reference block, R(k) is the rate associated with the filter index k, and {H^{k}} represents a set of filters initially configured and known to both encoder and decoder, with value k indicating filter number within this set which can contain any desired number of filters from 1 to any arbitrary number K. These filters are preferably obtained from a training set, and are known by both the encoder and the decoder.

Then the motion vector and filter index information, pair (MV,k), are sent for use by the decoder. After each MB is coded, the set of filters are updated to include the observation of local statistics, which requires gathering auto-correlation and cross-correlation data as described in a later section. The updated filters are used for the next macroblock (MB).

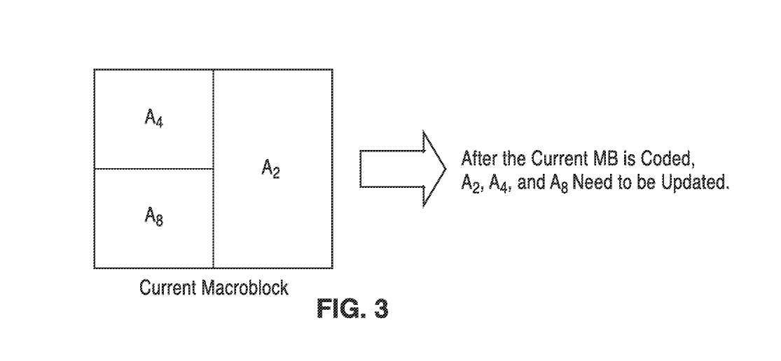

FIG. 3 illustrates that after the current MB is coded, then filters A2, A4, and A8 need to be updated.

The coding apparatus according to the invention provides updating auto-correlation and/or cross-correlation matrices. Letting y denote the current block and x be the reference block appointed by a motion vector, original auto-correlation matrix of class k is represented by Rₓₓ^{k}, while the cross-correlation matrix of class k is represented by R_{xy}^{k}.

Initial values of these matrices Rₓₓ^{k} (0) and R_{xy}^{k} (0) represent, respectively, the original auto-correlation and cross-correlation matrices of class k which are gathered from a training set, at each sub-pel position k. It should be noted that in at least one embodiment Rₓₓ^{k} and R_{xy}^{k} are hard-wired x wired into the decoder, whereby it is not necessary to transmit this information to the decoder.

Then, assuming a mean-squared error optimization, and using the well-known Wiener filter, the filters are then obtained according to

H^{k}=(Rₓₓ^{k})⁻¹R_{xy}^{k}.

The initial filter is computed as:

H^{k}(0)=[Rₓₓ^{k}(0)]⁻¹R_{xy}^{k}(0).

After an MB is coded, then Rₓₓ^{k} and R_{xy}^{k} are updated using the following formulas:

Rₓₓ^{k}(i+1)=(1−α)×Rₓₓ^{k}(i)+α×δRₓₓ^{k}(i)

R_{xy}^{k}(i+1)=(1−α)×R_{xy}^{k}(i)+α×δR_{xy}^{k}(i)

where the value α is a number between 0 and 1, while the changes (deltas) of Rₓₓ^{k} and R_{xy}^{k} are shown as δRₓₓ^{k} and δR_{xy}^{k}. It will be noted that there may exist more than one 4×4 block within the macroblock with the filter index k. The updating of the auto-correlation and/or cross-correlation matrices adapts the filters to the local statistics. The filter updating, at any time instance i, is given by the following formula:

H^{k}(i)=[Rₓₓ^{k}(i)]⁻¹R_{xy}^{k}(i)

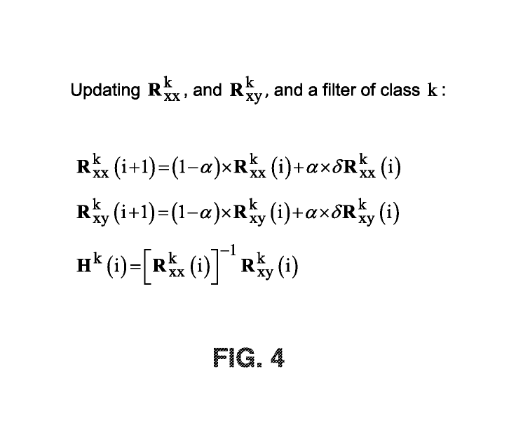

FIG. 4 depicts the equations above used for updating the correlation matrices.

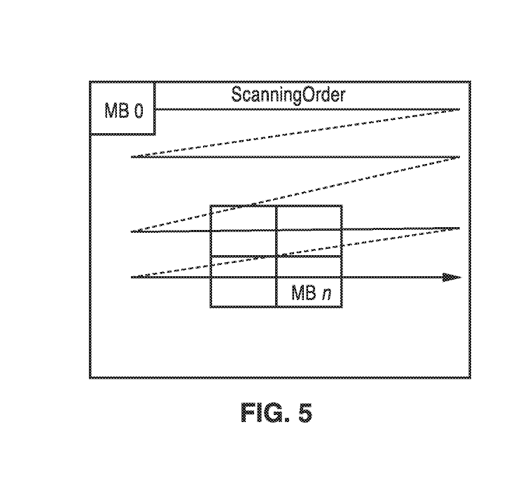

FIG. 5 illustrates macroblock scanning order in which scanning is performed in a zig-zag scan from MB 0 and on through the neighbors of MB i and finally current macroblock, MB i.

At least two ways are provided according to the present invention for extending RAIF to B pictures. In the first approach, the prediction vector x can be replaced with [x₁;x₂] where x₁ and x₂ are the forward (P pictures) and backward (B pictures) predictions, which become the same as the RAIF in P pictures, such as in this case having one filter associated to each block.

In the second approach, both x₁ and x₂ predictions are configured to to have their own filters, while the decoder is configured to update the auto-correlation and/or cross-correlation matrices for both forward and backward predictions. In at least one embodiment, the apparatus is configured to always update both auto-correlation and cross-correlation.

Filter indices are coded according to another element of the invention. In a typical fractional-pel Motion Compensating Prediction (MCP) the fractional part of the Motion Vectors (MVs) are transmitted together with the integer part of the MVs. By way of example and not limitation, MV (1.25, 2.75) is coded as (5,11) according to an element of the invention if quarter-pel Motion Estimation (ME) is used. It should be appreciated that this is described in a compatible manner with AIF, however, in RAIF the term “filter indices” has a substantially different meaning from how it is used in conveying conventional sub-pel positions. It should be appreciated that filter indices can be coded together with the full-pel motion vector (as in sub-pel MV coding within H.264/AVC) or performed separately as described below. First, in separately coding the filter indices, a prediction is obtained of the current filter index from neighboring filter indices. The difference between the predicted filter index and the current filter index is then coded. Finally, a Rate-Distortion (R-D) tradeoff between the filter choice and the prediction performance can be made. At the same time, the integer part of the MV is coded by itself, for instance by sending (1, 2) according to the above example.

For motion compensated prediction, a motion vector d is assigned to each block, referring to the corresponding position of its reference signal already transmitted. Motion vectors with a fractional-pel resolution may refer to positions in the reference image, located between the sampled positions of the image signal, whereby they are interpolated. As described previously, in AVC the interpolation is performed utilizing invariant filters, and in the present invention according to Recursive Adaptive Interpolation Filtering (RAIF) which can be utilized in either a single-pass or a two-pass encoder with the objective of minimizing the residual energy. It should be appreciated that since the design of these filters is based on the previously reconstructed sample values, the filters change on-the-fly as image encoding progresses. This method has two key characteristics: (1) The decoder can perform exactly the same computation to eliminate the need for transmitting filter coefficients on the side, and (2) the method allows spatial adaptability within an image.

The motion compensated prediction module of the invention utilizes the already transmitted signal in order to obtain a prediction. For this purpose, the spatial sampling rate of the reference image is increased by a factor of M for 1/M fractional pel (e.g., M=4 for quarter-pel resolution) and filtered with a set of interpolation filters {H^{k}}, (k=0, . . . M²−1), where k represents the indices of the filters, such as between 0 to 15.

Then, the interpolated signal is shifted according to the estimated motion vector d̅ₖ, referred to as motion compensation, and then down sampled by a factor M to produce the prediction signal. It should be noted that the index of the filter k is also reflected by the sub-pel position of the motion vector. It should be appreciated that Interpolation filters {H^{k}} may comprise a fixed set of filters as in AVC or can be adaptive, for instance functions of time, or other relationships.

Since the decoder has no access to the signal y, either the encoder has to signal the optimal filter set {H^{k}} as side information to the decoder, or the decoder has to derive {H^{k}} based on past statistics (e.g., context) utilizing the reconstructed sample values. In RAIF, the latter approach is taught using past statistics according to at least one implementation of the invention.

In this manner the interpolation filters {H^{k}} are both a function of time instance and location in the image. These filters are updated at specific (pre-defined) points in the video signal, referred to as “update points”.

Upon reaching the update point i+1, the updating of auto-correlation and cross-correlation matrices Rₓₓ^{k} and R_{xy}^{k} are computed using the reconstructed image signal between i and i+1 and its motion compensated reference.

It should be appreciated that only the filters that are used between update points i and i+1 need to be updated, whereby the new set of filters is computed accordingly. The decoder correspondingly performs computations to update its set of filters and therefore always remains in synchronization with the encoder.

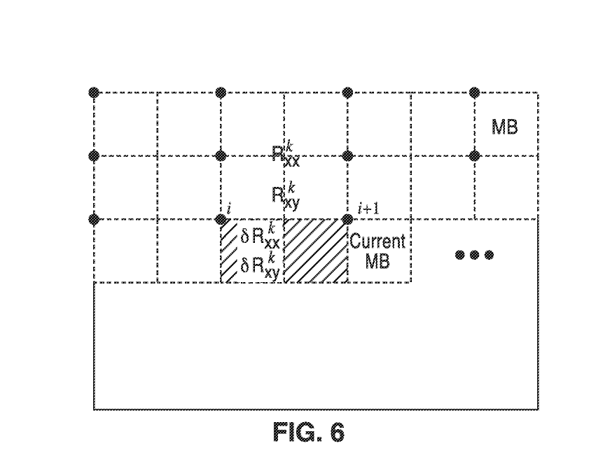

FIG. 6 illustrates decoded macroblocks with Rₓₓ^{k}, R_{xy}^{k}, δRₓₓ^{k}, δR_{xy}^{k}, and update points i and i+1. The updated points are shown as the large dots in the figure

In RAIF according to at least one embodiment of the invention, the selection of update points can be arbitrary. By way of example and not limitation, in the implementation described, the statistics were updated every one macroblock and the update points i and i+1 can arise across frames. Said another way, the statistics of the previously coded frame can be utilized for the next frame. However, at an Instantaneous Decoding Refresh (IDR) picture, the statistics have to be reset to Rₓₓ^{k} (0) and R_{xy}^{k} (0).

It should be appreciated that in an instantaneous decoding refresh (IDR) picture all slices are I (I picture) or SI (Switching I picture) slices which causes the decoding process to mark all reference pictures as “unused for reference” immediately after decoding the IDR picture. After decoding an IDR picture all following pictures are coded in decoding order and can be decoded without inter prediction from any picture decoded prior to the IDR picture. The first picture of each coded video sequence is an IDR picture.

In a single pass implementation, described by way of example and not limitation, the apparatus is configured to transmit a 1-bit signal for each Macroblock to switch between RAIF and AVC filtering. For blocks in which AVC filters are utilized, the auto-correlation and cross-correlation values are still computed for the update of RAIF, such that the set of filters in RAIF are gradually adapted to the local statistics. In a two-pass implementation a 1-bit signaling at the slice level can be utilized to indicate whether RAIF is to be selected. It should be appreciated that by modifying the α value, the programming of the apparatus can also control the speed of adaptation.

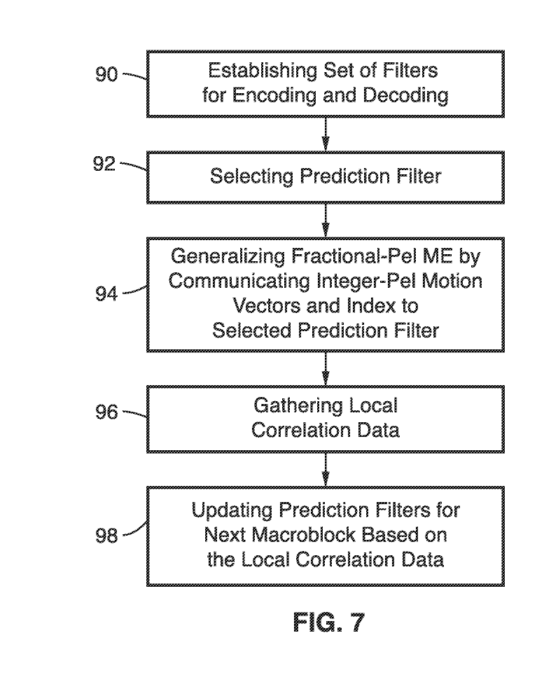

FIG. 7 illustrates an example embodiment of the present invention for prediction interpolation filtering of a video signal within a video decoder. A set of filters is established for encoding and decoding of the signal in block 90, a prediction filter selected 92, followed by communication of fractional-pel motion estimation (ME) 94 to the selected filter, collection 96 of local correlation data at decoded macroblock locations, and finally updating 98 of the prediction filters for the next macroblock based on the local correlation data.

From the description herein, it will be further appreciated that the invention can be embodied in various ways, which include but are not limited to the following. The present invention provides methods and apparatus for a video coding filter which utilizes recursive adaptive interpolation. Inventive teachings can be applied in a variety of apparatus and applications, including codecs, and other video processing apparatus.

As can be seen, therefore, the present invention includes the following inventive embodiments among others:

1. An apparatus for prediction interpolation filtering of a video signal having a sequence of frames within a video coder, comprising: a computer configured for processing video signals; and programming executable on said computer for, establishing an initial set of filters which are known for both encoding and decoding within a video coder, selecting a prediction filter, as a selected prediction filter, based on which filter optimizes accurate prediction for a macroblock, generalizing fractional-pel motion estimation of said macroblock by communicating integer-pel motion vectors and an index to a selected prediction filter, gathering local correlation data, updating the prediction interpolation filters utilized for the next macroblock based on said local correlation data.

2. The apparatus as recited in embodiment 1, wherein design of said prediction interpolation filters changes on-the-fly as image encoding progresses as prediction interpolation filter design is based on previously reconstructed sample values.

3. The apparatus as recited in embodiment 1, wherein said programming is configured for separately coding indices for said prediction interpolation filters, with a prediction obtained of a current filter index from neighboring indices.

4. The apparatus as recited in embodiment 1, wherein said prediction interpolation filtering is performed in a single pass.

5. The apparatus as recited in embodiment 1, wherein said local correlation data comprises auto-correlation data, and/or cross-correlation data.

6. The apparatus as recited in embodiment 1, wherein said updating of prediction interpolation filters comprises updating auto-correlation data Rₓₓ^{k}, and cross-correlation data R_{xy}^{k}, and a filter of class k is given by H^{k} using the following formulas:

Rₓₓ^{k}(i+1)=(1−α)×Rₓₓ^{k}(i)+α×δRₓₓ^{k}(i)

R_{xy}^{k}(i+1)=(1−α)×R_{xy}^{k}(i)+α×δR_{xy}^{k}(i)

H^{k}(i)=[Rₓₓ^{k}(i)]⁻¹R_{xy}^{k}(i)

where value α is a number between 0 and 1, while the changes (deltas) of Rₓₓ^{k} and R_{xy}^{k} are shown as δRₓₓ^{k} and δR_{xy}^{k} using prediction interpolation filter k at step i.

7. The apparatus as recited in embodiment 1: wherein said prediction interpolation filters can be different within a single frame of video, and adapt to spatial changes; and wherein said prediction interpolation filters are both a function of time instance and location in the image.

8. The apparatus as recited in embodiment 1, wherein said prediction interpolation filter coefficient side information is not sent to the decoder.

9. The apparatus as recited in embodiment 1, wherein said fractional-pel motion estimation comprises one-half pel positions, and/or one-quarter pel positions.

10. The apparatus as recited in embodiment 1, wherein said selecting a prediction interpolation filter is performed in response to

$${min}_{k} {‖ y - {H}^{k} \hat{x} ‖}_{1} + λ R ( k )$$

where y represents the original block, \hat{x} represents the reconstructed reference block, λ is a fixed multiplier, R(k) is the rate associated with the filter index k, and {H^{k}} represents a set of filters {H^{k}} initially configured and known to both encoder and decoder, with value k indicating filter number within this set which can contain any desired number of prediction interpolation filters.

11. The apparatus as recited in embodiment 10, wherein a motion vector (MV) and value k as a filter index are sent as pair (MV,k), to a decoder.

12. The apparatus as recited in embodiment 1, wherein said programming is configured during video decoding for performing its own computations to update its set of interpolation filters and remains in synchronization with an encoder.

13. The apparatus as recited in embodiment 1, wherein said programming is configured to transmit a 1-bit signal, from an encoder to a decoder, for selecting either recursive adaptive interpolation filters (RAIF) or filters for advanced video coding (AVC) standard.

14. An apparatus for interpolation filtering of a video signal having a sequence of frames within a video coder, comprising: a computer configured for processing video signals; and programming executable on said computer for, establishing an initial set of filters which are known for both encoding and decoding within a video coder, selecting a prediction filter, as a selected prediction filter, based on optimizing accurate prediction for a macroblock, generalizing fractional-pel motion estimation of said macroblock by communicating integer-pel motion vectors and an index to a selected prediction interpolation filter, gathering local correlation data comprising auto-correlation data, and/or cross-correlation data, performing prediction interpolation filtering in a single pass, as both a function of time instance and location in the image, updating the prediction filters utilized for the next macroblock based on said local correlation data.

15. The apparatus as recited in embodiment 14, wherein design of said prediction interpolation filters changes on-the-fly as image encoding progresses as prediction interpolation filter design is based on previously reconstructed sample values.

16. The apparatus as recited in embodiment 14, wherein said programming is configured for separately coding indices for said prediction interpolation filters, with a prediction obtained of a current filter index from neighboring indices.

17. The apparatus as recited in embodiment 14, wherein said updating of prediction interpolation filters comprises updating auto-correlation data Rₓₓ^{k}, and cross-correlation data R_{xy}^{k}, and a filter of class k is given by H^{k} using the following formulas:

Rₓₓ^{k}(i+1)=(1−β)×Rₓₓ^{k}(i)+α×δRₓₓ^{k}(i)

R_{xy}^{k}(i+1)=(1−α)×R_{xy}^{k}(i)+α×δR_{xy}^{k}(i)

H^{k}(i)=[Rₓₓ^{k}(i)]⁻¹R_{xy}^{k}(i)

where value α is a number between 0 and 1, while the changes (deltas) of Rₓₓ^{k} and R_{xy}^{k} are shown as δRₓₓ^{k} and δR_{xy}^{k} using prediction interpolation filter k at step i.

18. The apparatus as recited in embodiment 14: wherein said prediction interpolation filters can be different within a single frame of video, and adapt to spatial changes; and wherein said prediction interpolation filters are both a function of time instance and location in the image.

19. The apparatus as recited in embodiment 14, wherein said prediction interpolation filter coefficient side information is not sent to the decoder.

20. A method of performing prediction interpolation filtering of a video signal having a sequence of frames within a video coder, comprising: establishing an initial set of filters which is known for both encoding and decoding within a video coder; selecting a prediction filter, as a selected prediction filter, based on optimizing accurate prediction for a macroblock; generalizing fractional-pel motion estimation of said macroblock by communicating integer-pel motion vectors and an index to a selected prediction filter; gathering local correlation data; and updating the prediction interpolation filters utilized for the next macroblock based on said local correlation data.

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for prediction interpolation filtering of a video signal having a sequence of frames within a video coder, comprising:
a computer configured for processing video signals; and
programming executable on said computer for,
establishing an initial set of filters which are known for both encoding and decoding within a video coder,
selecting a prediction filter, as a selected prediction filter, based on which filter optimizes accurate prediction for a macroblock,
generalizing fractional-pel motion estimation of said macroblock by communicating integer-pel motion vectors and an index to a selected prediction filter,
gathering local correlation data, and
updating the prediction interpolation filters utilized for the next macroblock based on said local correlation data.

2. The apparatus as recited in claim 1, wherein design of said prediction interpolation filters changes on-the-fly as image encoding progresses as prediction interpolation filter design is based on previously reconstructed sample values.

3. The apparatus as recited in claim 1, wherein said programming is configured for separately coding indices for said prediction interpolation filters, with a prediction obtained of a current filter index from neighboring indices.

4. The apparatus as recited in claim 1, wherein said prediction interpolation filtering is performed in a single pass.

5. The apparatus as recited in claim 1, wherein said local correlation data comprises auto-correlation data, and/or cross-correlation data.

6. The apparatus as recited in claim 1, wherein said updating of prediction interpolation filters comprises updating auto-correlation data Rₓₓ^{k}, and cross-correlation correlation data R_{xy}^{k}, and a filter of class k is given by H^{k} using the following formulas:
Rₓₓ^{k}(i+1)=(1−α)×Rₓₓ^{k}(i)+α×δRₓₓ^{k}(i)
R_{xy}^{k}(i+1)=(1−α)×R_{xy}^{k}(i)+α×δR_{xy}^{k}(i)
H^{k}(i)=[Rₓₓ^{k}(i)]⁻¹R_{xy}^{k}(i)
where value α is a number between 0 and 1, while the changes (deltas) of Rₓₓ^{k} and R_{xy}^{k} are shown as δRₓₓ^{k} and δR_{xy}^{k} using prediction interpolation filter k at step i.

7. The apparatus as recited in claim 1:
wherein said prediction interpolation filters can be different within a single frame of video, and adapt to spatial changes; and
wherein said prediction interpolation filters are both a function of time instance and location in the image.

8. The apparatus as recited in claim 1, wherein said prediction interpolation filter coefficient side information is not sent to the decoder.

9. The apparatus as recited in claim 1, wherein said fractional-pel motion estimation comprises one-half pel positions, and/or one-quarter pel positions.

10. The apparatus as recited in claim 1, further comprising programming for selecting a prediction interpolation filter in response to the relation,
$${min}_{k} {‖ y - {H}^{k} \hat{x} ‖}_{1} + λ R ( k )$$
where y represents the original block, \hat{x} represents the reconstructed reference block, λ is a fixed multiplier, R(k) is the rate associated with the filter index k, and {H^{k}} represents a set of filters {H^{k}} initially configured and known to both encoder and decoder, with value k indicating filter number within this set which can contain any desired number of prediction interpolation filters.

11. The apparatus as recited in claim 10, wherein a motion vector (MV) and value k as a filter index are sent as pair (MV,k), to a decoder.

12. The apparatus as recited in claim 1, wherein said programming is configured during video decoding for performing its own computations to update its set of interpolation filters and remains in synchronization with an encoder.

13. The apparatus as recited in claim 1, wherein said programming is configured to transmit a 1-bit signal, from an encoder to a decoder, for selecting either recursive adaptive interpolation filters (RAIF) or filters for advanced video coding (AVC) standard.

14. An apparatus for interpolation filtering of a video signal having a sequence of frames within a video coder, comprising:
a computer configured for processing video signals; and
programming executable on said computer for,
establishing an initial set of filters which are known for both encoding and decoding within a video coder,
selecting a prediction filter, as a selected prediction filter, based on optimizing accurate prediction for a macroblock,
generalizing fractional-pel motion estimation of said macroblock by communicating integer-pel motion vectors and an index to a selected prediction interpolation filter,
gathering local correlation data comprising auto-correlation data, and/or cross-correlation data,
performing prediction interpolation filtering in a single pass, as both a function of time instance and location in the image, and
updating the prediction filters utilized for the next macroblock based on said local correlation data.

15. The apparatus as recited in claim 14, wherein design of said prediction interpolation filters changes on-the-fly as image encoding progresses as prediction interpolation filter design is based on previously reconstructed sample values.

16. The apparatus as recited in claim 14, wherein said programming is configured for separately coding indices for said prediction interpolation filters, with a prediction obtained of a current filter index from neighboring indices.

17. The apparatus as recited in claim 14, wherein said updating of prediction interpolation filters comprises updating auto-correlation data Rₓₓ^{k}, and cross-correlation data R_{xy}^{k}, and a filter of class k is given by H^{k} using the following formulas:
Rₓₓ^{k}(i+1)=(1−α)×Rₓₓ^{k}(i)+α×δRₓₓ^{k}(i)
R_{xy}^{k}(i+1)=(1−α)×R_{xy}^{k}(i)+α×δR_{xy}^{k}(i)
H^{k}(i)=[Rₓₓ^{k}(i)]⁻¹R_{xy}^{k}(1)
where value α is a number between 0 and 1, while the changes (deltas) of and R_{xy}^{k} are shown as δRₓₓ^{k} and δR_{xy}^{k} using prediction interpolation filter k at step i.

18. The apparatus as recited in claim 14:
wherein said prediction interpolation filters can differ within a single frame of video, and adapt to spatial changes; and
wherein said prediction interpolation filters are both a function of time instance and location in the image.

19. The apparatus as recited in claim 14, wherein said prediction interpolation filter coefficient side information is not sent to the decoder.

20. A method of performing prediction interpolation filtering of a video signal having a sequence of frames within a video coder, comprising:
establishing an initial set of filters which is known for both encoding and decoding within a video coder;
selecting a prediction filter, as a selected prediction filter, based on optimizing accurate prediction for a macroblock;
generalizing fractional-pel motion estimation of said macroblock by communicating integer-pel motion vectors and an index to a selected prediction filter;
gathering local correlation data; and
updating the prediction interpolation filters utilized for the next macroblock based on said local correlation data.
